(19) United States
(12) Patent Application Publication
(10) Pub. No.: US 2025/0008937 A1
(43) Pub. Date: Jan. 9, 2025

(54) FISHING SPINNING REEL

(71) Applicant: GLOBERIDE, Inc., Tokyo (JP)

(72) Inventor: Masashi FUJIOKA, Higashikurume-shi (JP)

(73) Assignee: GLOBERIDE, Inc., Tokyo (JP)

(21) Appl. No.: 18/746,378

(22) Filed: Jun. 18, 2024

(30) Foreign Application Priority Data
Jul. 3, 2023 (JP) 2023-109560

(51) Int. Cl. A01K 89/01

(52) U.S. Cl. CPC A01K 89/0117

(57) ABSTRACT

A reverse rotation prevention device that prevents reverse rotation of a rotor, and a switching mechanism that switches between a reverse rotation prevention state and a reverse rotation permission state in the reverse rotation prevention device are provided. The switching mechanism comprises a support shaft, an operation lever, and a U-shaped spring member. The support shaft is inserted and disposed in an inside of the spring member, the inside being recessed in a U-shape. The spring member is biased toward the inside having a U-shape and abuts on an outer surface of the support shaft. The support shaft is distributed and held at a reverse rotation prevention position where the reverse rotation prevention device is in a reverse rotation prevention state and a reverse rotation permission position where the reverse rotation prevention device is in a reverse rotation permission state.

### CROSS-REFERENCE TO RELATED APPLICATION

This application claims priority under 35 U.S.C. § 119 to Japanese Patent Application No. 2023-109560 filed on Jul. 3, 2023 in the Japanese Patent Office, the entire contents of each hereby incorporated by reference.

### BACKGROUND OF THE INVENTION

### 1. Technical Field

The present invention relates to a fishing spinning reel.

### 2. Description of the Related Art

Conventionally, a fishing spinning reel including a reverse rotation prevention device that prevents reverse rotation of a rotor is known (see, for example, JP 2010-273581 A). The reverse rotation prevention device of JP 2010-273581 A includes a switching lever for switching between a reverse rotation prevention state and a reverse rotation permission state in the reverse rotation prevention device at a lower portion of a body of a reel main body.

FIG. 7 is an enlarged cross-sectional view illustrating a configuration of a general switching mechanism of a conventional fishing spinning reel. As illustrated in FIG. 7, a reverse rotation prevention device 60 includes a support shaft 61 and a spring member 62. The support shaft 61 is configured to be rotatable between a reverse rotation prevention position where the reverse rotation prevention state is established by operating an operation lever 63 and a reverse rotation permission position where the reverse rotation permission state is established. The spring member 62 is configured to elastically abut on a distribution holding portion 64 of the support shaft 61 with a spring force to distribute and hold the rotation of the support shaft 61.

### SUMMARY OF THE INVENTION

The conventional reverse rotation prevention device 60 has a configuration in which the support shaft 61 and the spring member 62 are arranged vertically side by side in a body 65, and has a structure in which one end 62a of the spring member 62 abuts on the distribution holding portion 64 from an upper side of the support shaft 61. For this reason, the conventional reverse rotation prevention device 60 has a problem that an installation space of the support shaft 61 and the spring member 62 becomes large in an up-down direction of the body 65, and the body 65 becomes large.

Further, in the conventional reverse rotation prevention device 60, since the installation space of the support shaft 61 and the spring member 62 becomes large in the up-down direction, there is a possibility that formation positions of screw holes of a lid member (not illustrated) attached to the body 65 are restricted. Therefore, the conventional reverse rotation prevention device 60 does not respond to a request for improving strength of the body by arranging the screw holes of the lid member in a well-balanced manner.

The present invention has been made to solve such problems, and an object thereof is to provide a fishing spinning reel capable of improving strength of the body while reducing the size of the body.

In order to solve the above problems, the present invention comprises a rotor that rotates forward by a winding operation of a handle, a reverse rotation prevention device that prevents reverse rotation of the rotor, and a switching mechanism that switches between a reverse rotation prevention state and a reverse rotation permission state in the reverse rotation prevention device. The switching mechanism comprises a support shaft rotatably supported by a body of a reel main body, an operation lever attached to the support shaft, and a U-shaped spring member attached to the body. The support shaft is inserted and disposed in an inside of the spring member, the inside being recessed in a U-shape. The spring member is biased toward the inside having a U-shape and abuts on an outer surface of the support shaft. The support shaft is distributed and held at a reverse rotation prevention position where the reverse rotation prevention device is in a reverse rotation prevention state and a reverse rotation permission position where the reverse rotation prevention device is in a reverse rotation permission state by abutment of the spring member.

In the present invention, the support shaft of the switching mechanism can be inserted and arranged inside the U-shaped spring member to distribute and hold rotation of the support shaft to the reverse rotation prevention position and the reverse rotation permission position, and thus a distribution structure in which the support shaft is distributed to the reverse rotation prevention position in the reverse rotation prevention state and the reverse rotation permission position in the reverse rotation permission state can be accommodated in the installation space of the spring member. Therefore, the installation space of the switching mechanism can be reduced as compared with a case where the support shaft and the spring member are arranged side by side in the up-down direction of the body. Accordingly, the reel main body can be downsized.

Further, the installation space of the switching mechanism can be reduced, for example, and thus, in a case where the reel main body comprises the body and a lid member attached to the body, a screw hole forming space for fixing the lid member around the support shaft and the spring member can be ensured. Thus, a plurality of screw holes can be arranged at equal intervals or substantially equal intervals around the drive gear shaft to which the handle is attached. Therefore, the lid member can be attached to the body with the drive gear shaft as the center in a well-balanced manner, and strength of the body can be improved.

In the fishing spinning reel, it is preferable that the spring member comprises a bent portion having an arc shape and straight portions respectively continuous with both ends of the bent portion, and is attached to the body from a distal end side of the straight portion.

In this configuration, when the spring member is attached to the body, the spring member can be attached by placing a finger on an outer surface of the bent portion and pushing the spring member with the finger, so that a special tool or the like is unnecessary in the attachment. Therefore, productivity is improved.

It is preferable that one of the straight portions abuts on a wall surface formed in the body and is held by the body, and another of the straight portions abuts on an outer surface of the support shaft from a side opposite to a side on which the one of the straight portions is arranged to distribute and hold rotation of the support shaft between the reverse rotation prevention position and the reverse rotation permission position.

In this configuration, the another straight portion is biased toward the inside having a U-shape with one straight portion as a support portion, and thus a structure in which the another straight portion abuts on the outer surface of the support shaft on the inside having a U-shape can be easily constructed. Therefore, the structure of the switching mechanism is simple, and the productivity is excellent.

The fishing spinning reel preferably comprises a lid member attached to the body from a side of the body and supporting one end side of a drive gear shaft to which the handle is attached, and three screw holes that are formed in the body and into which fixing screws for fixing the lid member are screwed. In this case, it is preferable that the switching mechanism is disposed at a lower portion of the body, one of the three screw holes is formed around the spring member in the body, and the three screw holes are formed at equal intervals about a drive gear shaft to which the handle is attached.

In this configuration, the screw holes can be formed using an empty space around the spring member of the switching mechanism in the body, and thus the degree of freedom in forming the three screw holes is increased. In addition, since the three screw holes are formed at equal intervals around the drive gear shaft, the lid member can be fixed to the body in a well-balanced manner, and as a result, the strength of the body can be improved.

### Advantageous Effects of Invention

According to the present invention, it is possible to obtain a fishing spinning reel capable of improving the strength of a body while reducing the size of the body.

### BRIEF DESCRIPTION OF THE DRAWINGS

FIG. 1 is a side view illustrating an overall configuration of a fishing spinning reel according to one embodiment of the present invention;

FIG. 2 is a side view illustrating a configuration of a switching mechanism and an inside of a body in a partial cross section;

FIG. 3 is an enlarged side cross-sectional view illustrating a configuration of a switching mechanism;

FIG. 4 is a view illustrating a state when a U-shaped spring member is assembled to the body and a support shaft, and is an enlarged cross-sectional view taken along line IV-IV in FIG. 3;

FIGS. 5A and 5B are a view taken along line IV-IV in FIG. 3, in which FIG. 5A is an enlarged cross-sectional view illustrating a state in which the support shaft is rotatably held at a reverse rotation prevention position by operation of an operation lever, and FIG. 5B is an enlarged cross-sectional view illustrating a state in which the support shaft is rotatably held at a reverse rotation permission position by operation of the operation lever;

FIG. 6A is a main part perspective view illustrating a state in which the support shaft is rotatably held at a reverse rotation prevention position by operation of the operation lever; FIG. 6B is a main part perspective view illustrating a state in which the support shaft is rotatably held at a reverse rotation permission position by operation of the operation lever; and

FIG. 7 is an enlarged cross-sectional view illustrating a configuration of a general switching mechanism of a conventional fishing spinning reel.

### DETAILED DESCRIPTION

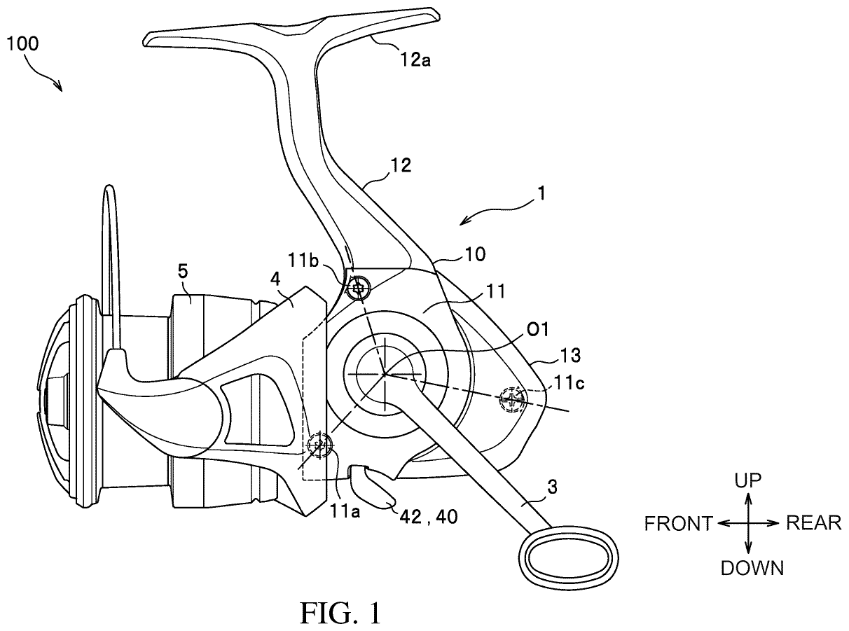

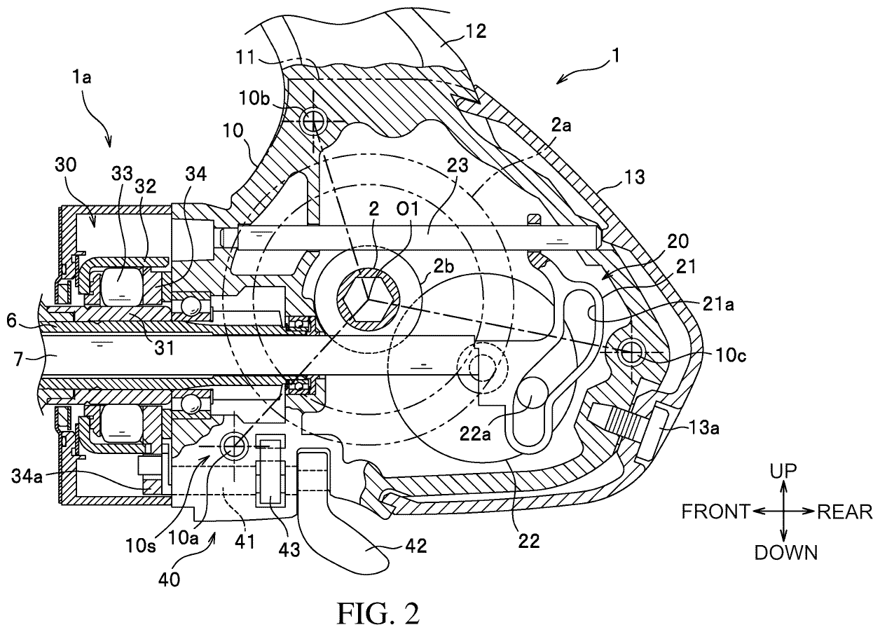

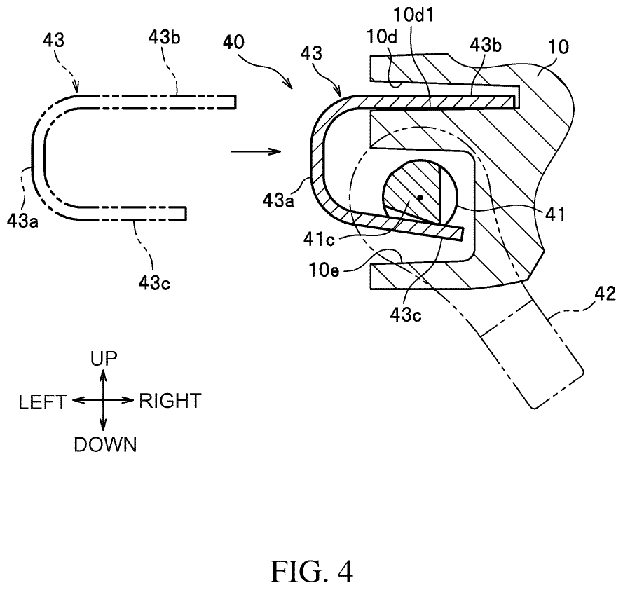

Next, a fishing spinning reel 100 according to an embodiment will be described with reference to the drawings. In the following description, terms “front and rear” and “up and down” are based on directions illustrated in FIG. 4, and terms “left and right” are based on directions illustrated in FIGS. 1 and 2.

### First Embodiment

First, a basic structure of the fishing spinning reel 100 will be described. As illustrated in FIG. 1, the fishing spinning reel 100 comprises a reel main body 1 to which a handle 3 is attached, a rotor 4 that is provided on a front side of the reel main body 1 and rotates forward by a winding operation of the handle 3, and a spool 5 that is provided on a front side of the rotor 4 and reciprocates in a front-rear direction by the winding operation of the handle 3.

The reel main body 1 comprises a body 10 and a lid member 11 attached to the body 10. A leg portion 12 extending upward is formed on an upper portion of the body 10. A rod attachment portion 12a to be attached to a fishing rod is formed at an upper end of the leg portion 12. A protective cover 13 is attached to a rear portion of the body 10 by an attachment screw 13a (see FIG. 2).

The lid member 11 is fixed to a left side surface of the body 10 by three fixing screws 11a to 11c. The lid member 11 supports one end side of a drive gear shaft 2. The fixing screw 11a is a screw for fixing the front portion of the lid member 11. The fixing screw 11b is a screw for fixing the upper portion of the lid member 11. The fixing screw 11c is a screw for fixing the rear portion of the lid member 11. The body 10 and the lid member 11 are integrated by screwing the fixing screws 11a to 11c. As illustrated in FIG. 2, the body 10 is formed with three screw holes 10a to 10c into which fixing screws 11a to 11c are screwed. Details of a configuration related to the arrangement of the screw holes 10a to 10c will be described later.

As illustrated in FIG. 2, a drive shaft cylinder 6 and a spool shaft 7 are assembled to the reel main body 1 so as to protrude forward from the front portion of the body 10. The rotor 4 (see FIG. 1) is attached to a front end of the drive shaft cylinder 6. The spool 5 (see FIG. 1) is attached to a front end of the spool shaft 7.

In the body 10, the drive gear shaft 2 extending in a left-right direction and a spool reciprocating device 20 are provided as a configuration for driving the drive shaft cylinder 6 and a spool shaft 8 in conjunction with the operation of the handle 3 (see FIG. 1).

The drive gear shaft 2 comprises a drive gear 2a and a gear 2b. The drive gear shaft 2 is rotatably supported by the lid member 11 and the body 10 via left and right ball bearings (not illustrated). A handle shaft (not illustrated) provided in the handle 3 is screwed to the drive gear shaft 2. Thus, the handle 3 and the drive gear shaft 2 rotate integrally.

The spool reciprocating device 20 comprises a slider 21 and an interlocking gear 22, and is configured so that the slider 21 moves in the front-rear direction along a guide shaft 23 extending in the front-rear direction of the body 10. The slider 21 is fixed to a rear end of the spool shaft 7 and comprises a guide trench 21a opened to the right side. The interlocking gear 22 is supported by a side wall of the body 10 and rotates while meshing with the gear 2b of the drive gear shaft 2. The interlocking gear 22 comprises an eccentric protrusion portion 22a that engages with the guide trench 21a of the slider 21.

As described above, when the drive gear shaft 2 and the gear 2b rotate by the winding operation of the handle 3, the interlocking gear 22 rotates, and the rotational motion is converted into a front-rear motion of the slider 21 via the eccentric protrusion portion 22a and the guide trench 21a. Thus, the spool shaft 7 (spool 5) reciprocates in the front-rear direction.

A reverse rotation prevention device 30 that prevents reverse rotation of the rotor 4 is assembled in the front portion 1a of the reel main body 1. On the other hand, a switching mechanism 40 for switching between the reverse rotation prevention state and the reverse rotation permission state in the reverse rotation prevention device 30 is provided in a lower portion of the body 10. The reverse rotation prevention state is a state in which rotation (forward rotation) of the drive shaft cylinder 6 and the rotor 4 in one direction, which is the winding direction of the fishing line, is permitted and rotation in the other direction (reverse rotation), which is the opposite direction, is prevented. The reverse rotation permission state is a state in which the drive shaft cylinder 6 and the rotor 4 are permitted to rotate in both directions (forward rotation and reverse rotation).

The reverse rotation prevention device 30 comprises an inner ring 31 externally fitted to the drive shaft cylinder 6, an outer ring 32 as an annular holding body, a plurality of rollers 33 disposed between the inner ring 31 and the outer ring 32, and a retainer 34 that retains the rollers 33. An annular protruding portion 34a that penetrates the outer ring 32 and protrudes radially outward is formed in a lower portion of the retainer 34. An engagement portion 41e to be described later of the switching mechanism 40 is inserted into and engaged with an annular hole portion of a protruding portion 34a. When the protruding portion 34a is moved in a circumferential direction in conjunction with the switching mechanism 40, the retainer 34 rotates around the central axis of the reverse rotation prevention device 30, and rotates to the reverse rotation prevention position to be in the reverse rotation prevention state and the reverse rotation permission position to be in the reverse rotation permission state. When the retainer 34 is rotated to the reverse rotation prevention position, each roller 33 exerts a wedge action between the inner ring 31 and the outer ring 32 to prevent the reverse rotation of the inner ring 31. Further, when the retainer 34 is rotated to the reverse rotation permission position, the wedge action is released to permit the forward rotation and the reverse rotation of the inner ring 31.

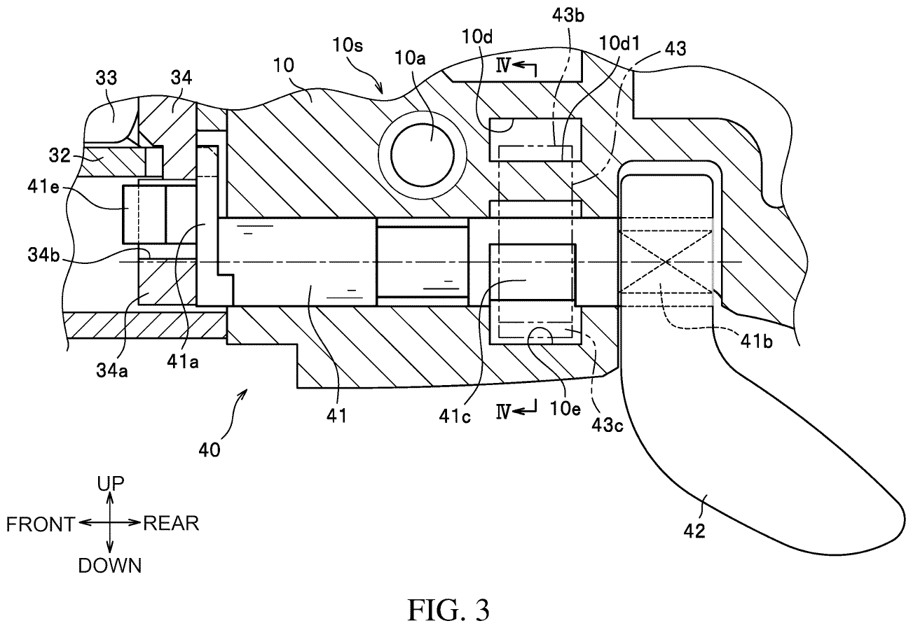

As illustrated in FIG. 3, the switching mechanism 40 comprises a support shaft 41 rotatably supported by a lower portion of the body 10, an operation lever 42 attached to the support shaft 41, and a spring member 43 attached to the body 10. As illustrated in FIG. 4, the spring member 43 is bent in a U-shape in rear view. The support shaft 41 is inserted and disposed in an inside of the spring member 43, the inside being recessed in a U-shape.

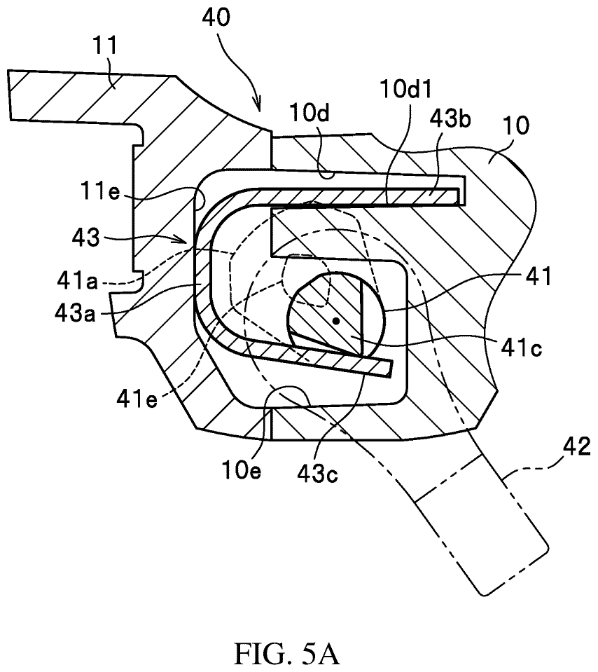

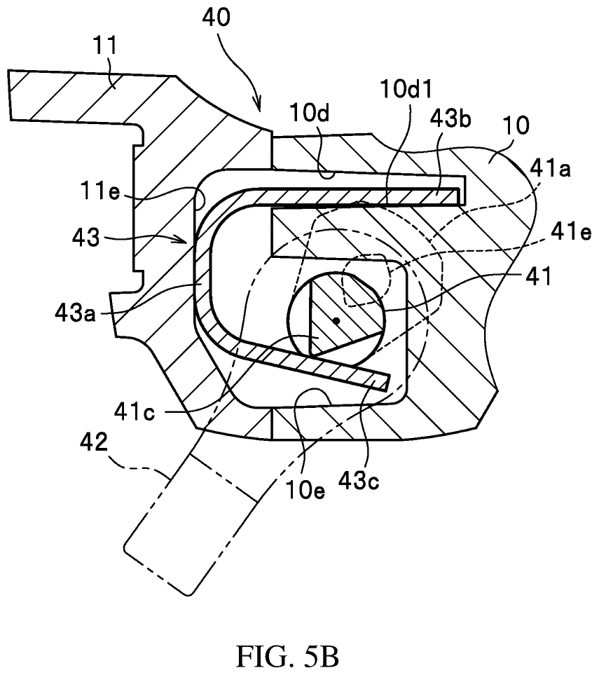

The support shaft 41 is a substantially columnar member extending in the front-rear direction of body 10. The engagement portion 41e (see FIGS. 3 and 5A) having a substantially elliptical cross section and protruding forward via a flange portion 41a is formed at a distal end portion of the support shaft 41. The engagement portion 41e is inserted into an insertion hole 34b formed in the protruding portion 34a of the retainer 34 of the reverse rotation prevention device 30, and is engaged with the protruding portion 34a so as to be swingable in the circumferential direction. By the engagement of the engagement portion 41e, the rotation operation of the support shaft 41 by the operation lever 42 (switching operation between the reverse rotation prevention state and the reverse rotation permission state) is transmitted to the reverse rotation prevention device 30 side.

The operation lever 42 is attached to a rear end of the support shaft 41. The operation lever 42 is a lever for rotating the support shaft 41, and protrudes downward from the lower portion of the body 10. The operation lever 42 is rotationally fixed to the support shaft 41 via a chamfered portion 41b formed on an outer surface of the support shaft 41. A distribution holding portion 41c is formed in a portion behind a central portion of the support shaft 41 (a portion near the front side of the operation lever 42). As illustrated in FIG. 4, the distribution holding portion 41c has an inverted triangular cross section. A lower straight portion 43c, which will be described later, of the spring member 43 abuts on a top portion of the distribution holding portion 41c with a spring force.

The spring member 43 is formed by bending a leaf spring member having a desired thickness into a U-shape. As illustrated in FIG. 4, the spring member 43 comprises an arc-shaped bent portion 43a, an upper straight portion 43b as one straight portion continuous with an upper end of the bent portion 43a, and a lower straight portion 43c as the other straight portion continuous with a lower end of the bent portion 43a. In a state before the spring member 43 is attached, the upper straight portion 43b and the lower straight portion 43c are substantially parallel as indicated by a two-dot chain line in FIG. 4. The upper straight portion 43b has a length larger than a length of the lower straight portion 43c in the left-right direction. Note that, in the spring member 43, the length of the lower straight portion 43c may be formed to be larger than a length of the upper straight portion 43b, and the length of the upper straight portion 43b and the length of the lower straight portion 43c may be formed to be the same.

As illustrated in FIG. 4, the spring member 43 is attached to the body 10 from distal end sides of the upper straight portion 43b and the lower straight portion 43c. With the spring member 43 attached to the body 10, the bent portion 43a protrudes to the side of the left side surface of the body 10. The lower straight portion 43c is biased toward the inside having a U-shape, and abuts on the top portion of the distribution holding portion 41c of the support shaft 41 from the lower side (from the side opposite to the side where the upper straight portion 43b is disposed). Due to the abutment of the lower straight portion 43c, the reverse rotation prevention device 30 (the retainer 34) interlocked with the switching mechanism 40 is distributed to and held at the reverse rotation prevention position to be in the reverse rotation prevention state and the reverse rotation permission position to be in the reverse rotation permission state. The lower straight portion 43c abuts on the distribution holding portion 41c and is elastically deformed when the operation lever 42 is switched.

A trench 10d into which the upper straight portion 43b is inserted and a recess 10e into which the lower straight portion 43c is inserted are formed on the left side surface of the body 10. The trench 10d and the recess 10e both open toward the left side of the body 10. The trench 10d has a size (depth) into which the upper straight portion 43b is inserted. The trench 10d comprises a flat abutting surface 10d1 as a wall surface on which the lower surface of the upper straight portion 43b abuts (is held).

As illustrated in FIGS. 3 and 4, the recess 10e has a size in which the distribution holding portion 41c and the lower straight portion 43c of the support shaft 41 are accommodated. That is, the recess 10e has a size that allows elastic deformation of the lower straight portion 43c at the time of switching operation of the operation lever 42. As illustrated in FIG. 5A, the spring member 43, the trench 10d, and the recess 10e are covered with the lid member 11 attached to the body 10. An accommodating recess 11e for accommodating the bent portion 43a of the spring member 43 is formed on the inner surface of the lid member 11. A left side surface of the bent portion 43a abuts on the inner surface of the accommodating recess 11e, and the housing recess 11e holds the bent portion 43a from the left side.

When the spring member 43 is attached to the body 10, as described above, the spring member is brought close to the body 10 from the distal end sides of the upper straight portion 43b and the lower straight portion 43c, the distal end portion of the upper straight portion 43b is inserted into the trench 10d, and the distal end portion side of the lower straight portion 43c is widened somewhat downward and inserted into the lower side of the distribution holding portion 41c. Then, a finger is put on the left side surface of the bent portion 43a to push the spring member 43 into the body 10. Thus, the spring member 43 can be attached to the body 10.

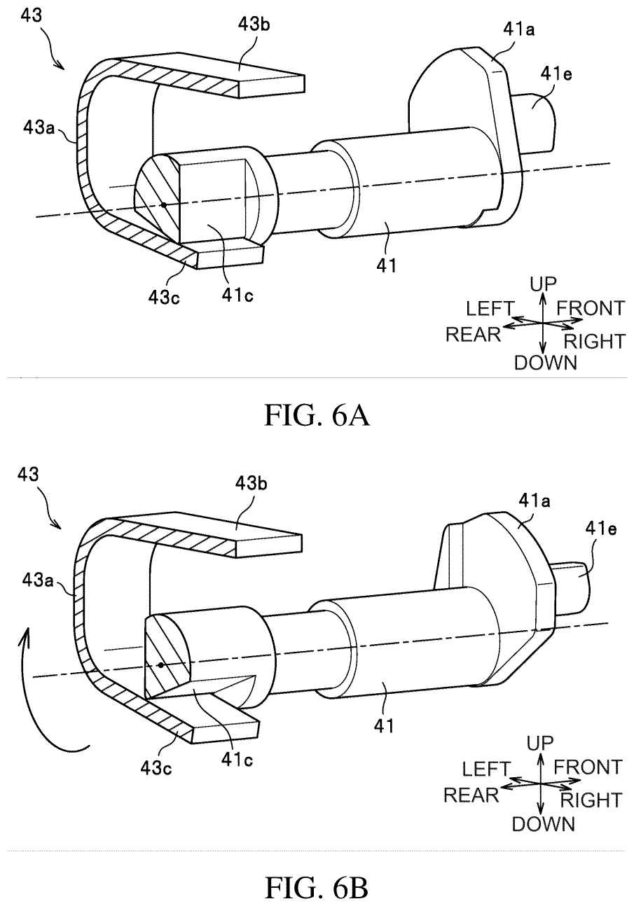

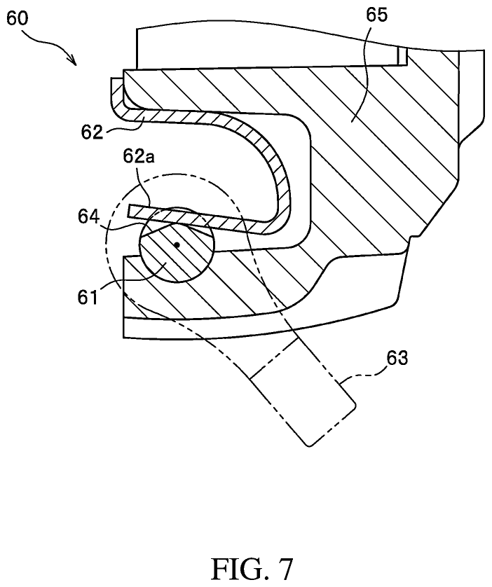

FIGS. 5A, 5B, 6A, and 6B are views illustrating the distribution and holding of the support shaft 41 by the spring member 43. As illustrated in FIGS. 5A and 6A, in a state where the support shaft 41 is rotated to the right side in the drawing by operation of the operation lever 42, the distribution holding portion 41c is held at the reverse rotation prevention position by the biasing force of the spring member 43. When the support shaft 41 is rotated to the reverse rotation prevention position, the rotation of the support shaft 41 is transmitted to the retainer 34 via the engagement portion 41e, and the retainer 34 is rotated to the reverse rotation prevention position. Thus, the reverse rotation prevention device 30 is brought into the reverse rotation prevention state.

On the other hand, as illustrated in FIGS. 5B and 6B, in a state where the support shaft 41 is rotated to the left side in the drawing by operation of the operation lever 42, the distribution holding portion 41c is held at the reverse rotation permission position by the biasing force of the spring member 43. When the support shaft 41 is rotated to the reverse rotation permission position, the rotation of the support shaft 41 is transmitted to the retainer 34 via the engagement portion 41e, and the retainer 34 is rotated to the reverse rotation permission position. Thus, the reverse rotation prevention device 30 is brought into the reverse rotation permission state. Note that, as illustrated in these drawings, holding of the support shaft 41 by the spring member 43 is performed in the inside having a U-shape of the spring member 43. That is, the support shaft 41 can be distributed and held by effectively using the inner space of the spring member 43 having a U-shape.

Next, a space formed around the switching mechanism 40 will be described. As described above, the switching mechanism 40 of the present embodiment has a configuration in which the support shaft 41 is inserted and arranged in the inside of the spring member 43, the inside being recessed in a U-shape (see FIG. 3). Therefore, as compared with a configuration in which the support shaft and the spring member are arranged side by side vertically, it is possible to suppress the upward protrusion of the spring member 43, and as a result, it is possible to reduce the installation space of the switching mechanism 40 in the up-down direction. Thus, in the present embodiment, the entire switching mechanism 40 is arranged to be shifted to the rear side of the body 10 while preventing interference with the drive shaft cylinder 6 and other constituent members arranged above the switching mechanism 40. With this arrangement of the switching mechanism 40, as illustrated in FIGS. 2 and 3, it is possible to form a space 10s of the screw hole 10a around the spring member 43. A fixing screw 11a for fixing the lid member 11 is screwed into the screw hole 10a.

Here, in the configuration in which the support shaft and the spring member are arranged side by side vertically, because it is necessary to take a wide space for arranging the spring member in the lower portion of the body, and interference with constituent members of the body occurs, it is not possible to set the arrangement space of the screw holes around the spring member, and for example, it is necessary to form the screw holes in the lowermost end of the body behind the switching mechanism. On the other hand, in the present embodiment, since the screw hole 10a can be formed in the space 10s around the spring member 43 above the lowermost end of the body 10, the degree of freedom in the positional relationship with the other screw holes 10b and 10c is improved.

In the present embodiment, as illustrated in FIG. 2, three screw holes 10a to 10c are formed at equal intervals of 120 degrees (dashed-dotted lines drawn from an axis O1 of the drive gear shaft 2 so as to pass through respective centers of the screw holes 10a to 10c are equally spaced) around the drive gear shaft 2 to which the handle 3 is attached. The screw hole 10b is formed in the upper portion of the body 10, and the fixing screw 11b for fixing the upper portion of the lid member 11 is screwed thereinto. The screw hole 10c is formed in the rear portion of the body 10, and the fixing screw 11c for fixing the rear portion of the lid member 11 is screwed thereinto. Note that the screw holes 10a to 10c are not limited to those formed at equal intervals, and may be formed at different intervals from the screw holes 10b and 10c with reference to the screw holes 10a.

According to the present embodiment described above, since the support shaft 41 of the switching mechanism 40 can be inserted and arranged in the inside of the spring member 43 having a U-shape to distribute and hold rotation of the support shaft 41 between the reverse rotation prevention position and the reverse rotation permission position, the distribution holding portion 41c (distribution mechanism) can be accommodated in the installation space of the spring member 43. Therefore, the installation space of the switching mechanism 40 can be reduced as compared with the case where the support shaft and the spring member are arranged side by side in the up-down direction of the body. Accordingly, the reel main body 1 can be downsized.

In addition, since the installation space of the switching mechanism 40 can be reduced, the formation space of the screw hole 10a on the front side for fixing the lid member 11 can be ensured around the support shaft 41 and the spring member 43 (in particular, the front side or the like of the spring member 43). Thus, the screw holes 10a to 10c can be arranged at equal intervals or substantially equal intervals around the drive gear shaft 2 to which the handle 3 is attached. Therefore, the lid member 11 can be attached to the body 10 with the drive gear shaft 2 as the center in a well-balanced manner, and the strength of the body 10 can be improved.

Further, when the spring member 43 is attached to the body 10, the spring member 43 can be attached thereto by placing a finger on an outer surface (left side surface) of the bent portion 43a and pushing the spring member with the finger, so that a special tool or the like is unnecessary at the time of attachment. Therefore, productivity is improved.

In addition, since the screw hole 10a can be formed using the space 10s around the spring member 43 of the switching mechanism 40 in the body 10, the degree of freedom in forming the three screw holes 10a to 10c is increased. In addition, since the three screw holes 10a to 10c are formed at equal intervals around the drive gear shaft 2, the lid member 11 can be fixed to the body 10 in a well-balanced manner, and as a result, the strength of the body 10 can be improved.

In addition, since the lower straight portion 43c is biased toward the inside having a U-shape with the upper straight portion 43b as a support portion, it is possible to easily construct a structure in which the lower straight portion 43c abuts on the top portion of the distribution holding portion 41c that becomes the outer surface of the support shaft 41 in the inside having a U-shape. Therefore, the structure of the switching mechanism 40 is simple, and the productivity is excellent.

Although the embodiments have been described above, the present invention is not limited to the examples described in the embodiments. For example, in the above embodiment, the abutting surface 10d1 on which the lower surface of the upper straight portion 43b abuts is formed in the trench 10d but the present invention is not limited thereto, and for example, a wall surface formed to be exposed in the body 10 may be used as the abutting surface 10d1.

In addition, although the distribution holding portion 41c is formed in an inverted triangular cross section but the present invention is not limited thereto, and various shapes can be employed as long as the support shaft 41 can be distributed and held at the reverse rotation prevention position and the reverse rotation permission position.

### REFERENCE SIGNS LIST

1 Reel main body
2 Drive gear shaft
3 Handle
4 Rotor
10 Body
10a to 10c Screw hole
11 Lid member
11a to 11c Fixing screw
30 Reverse rotation prevention device
40 Switching mechanism
41 Support shaft
42 Operation lever
43 Spring member
43a Bent portion
43b Upper straight portion (one straight portion)
43c Lower straight portion (other straight portion)
100 Fishing spinning reel
O1 Axis

What is claimed is:

1. A fishing spinning reel comprising:
a rotor that rotates forward by a winding operation of a handle;
a reverse rotation prevention device that prevents reverse rotation of the rotor; and
a switching mechanism that switches between a reverse rotation prevention state and a reverse rotation permission state in the reverse rotation prevention device, wherein
the switching mechanism
comprises a support shaft rotatably supported by a body of a reel main body, an operation lever attached to the support shaft, and a U-shaped spring member attached to the body,
the support shaft is inserted and disposed in an inside of the spring member, the inside being recessed in a U-shape,
the spring member is biased toward the inside having a U-shape and abuts on an outer surface of the support shaft, and
the support shaft is distributed and held at a reverse rotation prevention position where the reverse rotation prevention device is in a reverse rotation prevention state and a reverse rotation permission position where the reverse rotation prevention device is in a reverse rotation permission state by abutment of the spring member.

2. The fishing spinning reel according to claim 1, wherein
the spring member
comprises a bent portion having an arc shape and straight portions respectively continuous with both ends of the bent portion, and
is attached to the body from a distal end side of the straight portion.

3. The fishing spinning reel according to claim 2, wherein one of the straight portions abuts on a wall surface formed in the body and is held by the body, and another of the straight portions abuts on an outer surface of the support shaft from a side opposite to a side on which the one of the straight portions is arranged to distribute and hold rotation of the support shaft between the reverse rotation prevention position and the reverse rotation permission position.

4. The fishing spinning reel according to claim 1, further comprising:
a lid member attached to the body from a side of the body and supporting one end side of a drive gear shaft to which the handle is attached, and three screw holes that are formed in the body and into which fixing screws for fixing the lid member are screwed, wherein
the switching mechanism is disposed at a lower portion of the body,
one of the three screw holes is formed on a front side of the spring member in the body, and
the three screw holes are formed at equal intervals around a drive gear shaft to which the handle is attached.
